(19) United States
(12) Patent Application Publication
(10) Pub. No.: US 2014/0136835 A1
(43) Pub. Date: May 15, 2014

(54) SECURE COMPUTER NETWORK

(71) Applicant: Cassidian Limited, Newport South Glamorgan (GB)

(72) Inventor: Martin Sharpe, Newport Gwetn (GB)

(73) Assignee: Cassidian Limited, Newport South Glamorgan (GB)

(21) Appl. No.: 14/122,032

(22) PCT Filed: May 24, 2012
(86) PCT No.: PCT/GB2012/051179

§ 371 Date: Jan. 6, 2014

(30) Foreign Application Priority Data
May 25, 2011 (GB) 1108816.8

(51) Int. Cl. H04L 29/06

(52) U.S. Cl. CPC H04L 63/0464
USPC 713/153

(57) ABSTRACT

A computer network (10) comprises a private network (20). At least one interface (40) is connected to the private network (20) and configured to encrypt, with a first encryption key, data that is leaving the private network (20). A compliance check apparatus (70) includes at least one interface (60) that is connected to the compliance check apparatus (70) and that is configured to decrypt data encrypted with the first encryption key that is entering the compliance check apparatus (70). The compliance check apparatus (70) is configured to check that the decrypted data complies with a first condition. At least one further interface (80) is connected to the compliance check apparatus (70) and is configured to encrypt with a second encryption key checked, decrypted data that is leaving the compliance check apparatus (70). In example embodiments of the invention, a corresponding work-flow is provided for data entering the private network (20).

### FIELD OF THE INVENTION

The present invention concerns secure computer networks.

### BACKGROUND OF THE INVENTION

Some Information and Communication Technologies (ICT) Systems are designed for security reasons to be not interconnected (for example by any network connection) to any other ICT system, but rather to be isolated from all other ICT Systems by a so-called “air gap”. Isolation of an ICT system in that way greatly reduces the risk of unwanted data being introduced into the system, or of data being accidentally or deliberately leaked from the system, because all data transfer into and out from the system must be by removable media, rather than a potentially vulnerable permanent network connection. The removable media can itself be subject to the kind of handling restrictions that are normally applied to sensitive documents.

Often, there is a need to control all data transfer to a network, even by privileged ICT managers (who may need to introduce software updates virus updates, for example, or other data relating to the function of the network). Another advantage of using removable media is that it can be subject to a compliance check prior to insertion into a media reader, for example a check as to the nature or classification of the data (and e.g. that its removal is permissible), or an antivirus check or other malware check.

Unfortunately, compliance with handling restrictions and other compliance checks is dependent upon the cooperation of the person bringing the removable media into the system or removing it from the system. There is a risk of the person forgetting to comply with the procedure imposed by the handling restrictions and compliance checks. There is also a risk, albeit smaller than the risk of non-compliance through forgetfulness, that the person will deliberately circumvent the procedure, for example in order to introduce malware deliberately into the system, or to extract data improperly from the system.

Thus, data transfers between systems and companies at present involve significant manual overheads and rely on a fundamental trust that people involved in the transfer will follow specified procedures that have been designed to ensure that restrictions and checks are complied with. The use of cheap, easy to use, reusable and readily available memory sticks for data transfer is not permitted on many systems, due to security concerns. That raises the cost of data transfer and can result in significant quantities of media being disposed of after only one use.

Some secure networks are of a sufficiently low sensitivity for a connection to another network (i.e. no isolation by an air gap) to be acceptable. Even in for those secure networks, however, it is important that specified procedures are followed and restrictions and checks complied with.

The present invention seeks to mitigate the above-mentioned problems.

### SUMMARY OF THE INVENTION

The present invention provides, according to a first aspect, a method of enforcing a data transfer policy when data is communicated from a private network, the method comprising ensuring that data can only be transferred via approved routes, through one or more intermediate compliance checkers, by:

encrypting, with a first encryption key, data that is leaving the private network;

transmitting the encrypted data to a compliance checker;

decrypting the encrypted data at the compliance checker;

checking that the decrypted data complies with a first condition; and

encrypting with a second, different, encryption key the checked, decrypted data.

The present invention also provides, according to a second aspect, a method of enforcing a data transfer policy when data is communicated to a private network, the method comprising ensuring that data can only be transferred via approved routes, through one or more intermediate compliance checkers, by:

receiving data that is encrypted with a first encryption key;

decrypting the encrypted data;

checking that the decrypted data complies with a first condition;

encrypting with a second, different, encryption key the checked, decrypted data;

transmitting the encrypted, checked data to a private network; and

decrypting the encrypted, checked data at the private network.

The present invention also provides, according to a third aspect, a computer network comprising:

a private network;

at least one interface connected to the private network and configured to encrypt, with a first encryption key, data that is leaving the private network;

a compliance check apparatus;

at least one interface connected to the compliance check apparatus and configured to decrypt data encrypted with the first encryption key that is entering the compliance check apparatus;

wherein the compliance check apparatus is configured to check that the decrypted data complies with a first condition; the computer network further comprising

at least one further interface connected to the compliance check apparatus and configured to encrypt with a second, different, encryption key checked, decrypted data that is leaving the compliance check apparatus.

The present invention also provides, according to a fourth aspect, a computer network comprising:

a compliance check apparatus;

at least one interface connected to the compliance check apparatus and configured to decrypt data, encrypted with a first encryption key, that is entering the compliance check apparatus;

wherein the compliance check apparatus is configured to check that the decrypted data complies with a first condition, the computer network further comprising

at least one further interface connected to the compliance check apparatus and configured to encrypt with a second, different, encryption key checked, decrypted data that is leaving the compliance check apparatus;

a private network; and

at least one interface connected to the private network and configured to decrypt data, encrypted with the second encryption key, that is entering the private network.

The present invention also provides, according to a fifth aspect, a method of communicating data from a private network, the method comprising:

encrypting, with a first encryption key, data that is leaving the private network;

transmitting the encrypted data to a compliance checker;

decrypting the encrypted data at the compliance checker;

checking that the decrypted data complies with a first condition; and

encrypting with a second encryption key the checked, decrypted data.

The present invention also provides, according to a sixth aspect, a method of communicating data to a private network, the method comprising:

receiving data that is encrypted with a first encryption key;

decrypting the encrypted data;

checking that the decrypted data complies with a first condition;

encrypting with a second encryption key the checked, decrypted data;

transmitting the encrypted, checked data to a private network; and

decrypting the encrypted, checked data at the private network.

Thus the invention enables a network to be secured. The invention uses at least one encryption/decryption pair of interfaces that define a route for data transfer into or out from the private network. By limiting knowledge of the encryption key(s) to a small number, preferably two, devices, distinct domains are created, which ensures that data can only be transferred via approved routes through one or more intermediate compliance checking apparatuses. Thus, there is only one, or a limited number, of ingress/egress routes by which data can be introduced/removed from the system. The private network will be configured such that there are no other routes into or out from it; i.e., all data entering or leaving the private network must pass through the compliance check. Embodiments of the invention may thus provide effective enforcement of ingress and egress routes to and from sensitive domains for users (preferably including privileged users). Advantageously, as data must pass along the encryption-key controlled workflow, in at least some embodiments of the invention, users, administrators and maintainers of the private network can be prevented from introducing data onto the network without enforced virus checking.

Thus, example embodiments of the invention can provide technical enforcement of a data transfer policy. Enforcement by technical means has the advantage that it is much less susceptible to mistakes, inadvertent lapses and deliberate attack than relying on human operators to comply with policies and procedures. For example, some example embodiments of the invention are arranged to ensure that all data removed from the private network, by removable electronic media or otherwise, is encrypted. (The encryption should of course be to a level appropriate for the sensitivity of the data.) It then does not matter if, for example, data is lost, intercepted or stolen after it leaves the network, because it is appropriately encrypted.

Whilst the method ensures that data leaving the network is encrypted, its utility is not limited to sensitive data which must be encrypted. Ingress and egress of all data into and out from the network is controlled, including for example non-sensitive data, for example software updates and the like. Advantageously a pre-existing network can readily be converted into a network embodying the invention.

The checking that the data complies with a first condition may be for example be a check that the data does not contain malware (e.g. a computer virus) or a check that the data is data of a kind that is allowed to be added to or removed from the private network (e.g. a check of its classification level).

There may be one or more further compliance check, enforced by sharing an encryption key between an input interface of a device that performs the further compliance check and an output interface of a device from which data to be checked for compliance is received, and sharing a different encryption key between an output interface of the device that performs the further compliance check and the input interface of a device to which the data that is to be sent after it has been checked for compliance. For example, there may be a two-stage virus check. The two-stage virus check may comprise a first stage in which the received data is checked for viruses by a first virus checker, and a second stage in which the received data is checked for viruses by a second, different, virus checker. It may be that the first virus checker is connected to an output interface, wherein the output interface is configured to encrypt with a unique encryption key virus-checked data that is leaving the virus checker, and that the second virus checker is connected to an input interface that is configured to decrypt the data when it receives it from the output interface. The second virus checker may also be connected to an output interface that is configured to encrypt with a different unique encryption key virus-checked data that is leaving the second virus checker.

It may be that the compliance check, or the further compliance check, is a manual check. It may be that the compliance check, or the further compliance check, is an automated check.

It may be that the further compliance check is for example a check that the data does not contain malware (e.g. a computer virus) or a check that the data is data of a kind that is allowed to be added to or removed from the private network (e.g. a check of its classification level).

It may be that the compliance check, or the further compliance check, is a check that the data conforms with rules regarding data release (for example, that its release is authorised). For example, the compliance check apparatus may be arranged to allow a person (e.g. a data output operator or information manager) to check the data being removed from the private network, independently from an originator (i.e. the person who initiated the removal). Thus, a two-man rule may be enforced, as required by many system operating procedures. For particularly sensitive data, there may be two or even more such checks, each enforced by providing a chain of encryption key domains.

Optionally, each encryption key is shared only between one pair of the interfaces; that has the advantage of providing a linear workflow path into and out from the private network. Thus, it may be that there is only one route into and out from the private network. Alternatively one or more of the encryption keys may be shared between three or more of the interfaces, such that data encrypted by an interface sharing the key may be unencrypted by the two or more others of the interfaces sharing the key. Although likely to be less secure than restricting the keys to pairs of interfaces, sharing between three or more interfaces may be advantageous in some situations, for example when the private network is large and several parallel input or output routes are required (for example through two or more parallel virus checkers).

Preferably, there is a plurality of different encryption keys each uniquely paired with a plurality of destination interfaces. Note that optionally an interface may share more than one encryption key, i.e. it may belong to more than one key domain.

It may be that the private network is not directly connected to any other computer network; i.e. there may be an air gap within one or more pairs of the interfaces. It may be that there are air gaps within all pairs of the interfaces. Use of an air gap is inherently more secure than any network connection. It also makes auditing of transferred data more straightforward.

It may be that data is transmitted between at least one pair of the interfaces, preferably between all of the interfaces, on removable media. The removable media may be for example a data storage device connected by a USB or other interface, a CD-ROM, or a DVD. Advantageously, in some example embodiments of the invention, the removable media can be used over and over again, i.e. there are no issues with remanence. It may be that the interface connected to the private network is the only device connected to the private network that is capable of writing and/or reading data to removable media or to a network connection.

Alternatively, it may be that data is transmitted between at least one pair of the interfaces, or even between all of the interfaces, over one or more network connections. In cases in which the data is of a relatively low sensitivity (for example when it is commercially sensitive rather than sensitive in view of national-security considerations), or when it has been reduced to a sufficiently low level of sensitivity, as a result of the encryption, instead of being transferred by removable media, it can be transferred by other means. The data may be transmitted by for example FTP or e-mail.

It will be understood that the network may include PCs, servers, peripherals, laptops, handhelds, and/or other devices. It may be that all output peripherals (e.g. stand-alone peripherals such as printers) that are connected to the private network are connected to the private network via an interface pair, in order to manage and enforce a route to release of all data.

The interfaces may carry out the encryption and/or the decryption in hardware or in software; preferably, the encryption and the decryption are carried of in hardware, for example using Cassidian Limited's ECTOCRYP YELLOW® product. The interfaces may be hardware devices connected directly to their respective functional devices, i.e. to the network, or to a compliance check apparatus. Use of such separate hardware devices as the interfaces has the advantage of removing any dependence on platform capabilities e.g. BIOS peculiarities.

In advantageous example embodiments of the invention, at least some, preferably all, of the encryption steps are encryption, for example using a High Grade Block Cipher and an identifier code in the data, such that if the data is altered in any way then the decryption process will fail. Thus, it may be that, in such example systems, any malware or added illegal data cannot be placed onto the private network as it will fail the decryption process. Of course, any unencrypted data will not be passed through the decryption process, and so viruses or other malware introduced independently or attached to legitimate data will automatically be blocked.

Preferably, the encryption is sufficiently strong that the encrypted data is essentially unreadable by 3^{rd} parties. For example, the encryption may be sufficiently strong that the encrypted data is unclassified, regardless of the confidentiality classification of the unencrypted data. Use of such strong encryption eliminates for example the need to use couriers to take working copies of documents to workshare partners. Examples of embodiments of the invention may also eliminate the need to record manually details of such transactions in document logs. It may be that software applications interfacing with an interface maintain a log of all data transfers to or from that interface (thus easing the burden of manual registration of transmission of secure data media).

In the computer network, it may be that any or all of the interfaces doing encryption only do encryption; alternatively they may also do decryption. It may be that any or all of the interfaces doing decryption only do decryption; alternatively they may also do encryption.

It may be that all data written by the interfaces is encrypted; that ensures that all sensitive data is encrypted when not on the network.

In some embodiments, it is not necessary for all data written by all of the interfaces of the computer network to be encrypted. For example, it may on some occasions be desirable to send non-confidential or public information, e.g. a press release, from the private network to the Internet or another public network; in such a case, data leaving the computer network from the compliance check apparatus need not be encrypted.

Thus example embodiments of the invention may provide a way to render all digital transfer media (e.g. memory sticks, CDs, DVDs, HDTs) unclassified, to enforce controlled ingress and egress routes to ICT systems, to enforce virus checking, to reduce or eliminate the impact of accidental loss, to significantly reduce the risk of malware or virus introduction to ICT systems, and to enable compliance to specified security policies in data handling.

It will of course be appreciated that features described in relation to one aspect of the present invention may be incorporated into other aspects of the present invention. For example, either of the methods of the invention may incorporate any of the features described with reference to either or both of the computer networks of the invention and vice versa.

### DESCRIPTION OF THE DRAWINGS

Embodiments of the present invention will now be described by way of example only with reference to the accompanying schematic drawings of which:

FIG. 1 is a system diagram showing a computer network according to a first example embodiment of the invention;

FIG. 2 is a system diagram showing a computer network according to a second example embodiment of the invention; and

FIG. 3 is a system diagram showing a computer network according to a third example embodiment of the invention.

### DETAILED DESCRIPTION

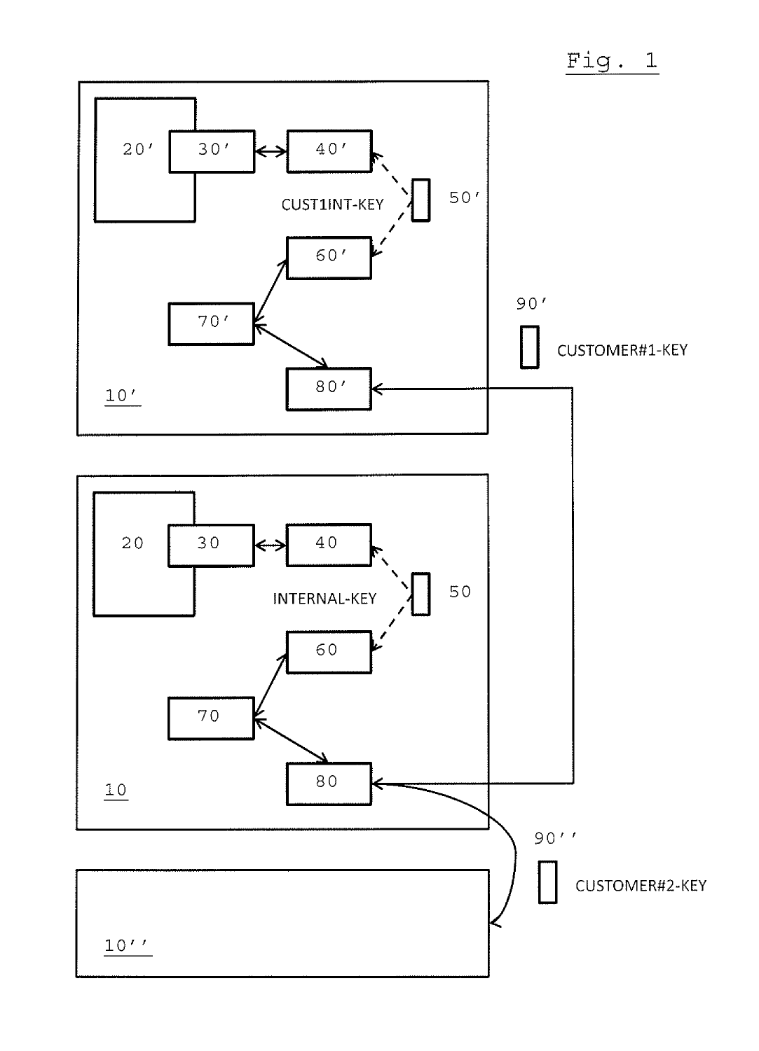

In a first example embodiment of the invention (FIG. 1), a computer network 10 includes a secret network 20. The secret network 20 includes an interface PC 30. The interface PC 30 is connected to an interface unit 40, which includes a USB port. The interface unit 40 is the only device in the secret network 20 that is capable of writing to or reading from removable media. The secret network 20 is not connected by any other means to any other computer network.

Consequently, the only way that data can be introduced or removed from the secret network 20 is via a USB data storage device, such as a USB stick 50.

The interface unit 40 is configured so that any data that it writes to the USB stick 50 is encrypted. The encryption uses a first key INTERNAL-KEY.

The computer network 10 also comprises a secret stand-alone virus checker PC 70. The secret stand-alone virus checker PC 70 is connected to two further interface units 60, 80, each including a USB port. The first interface unit 60 is configured to decrypt the data on the USB stick encrypted using the first key INTERNAL-KEY. The first interface unit 60 is the only device other than the interface unit 40 to have the first key INTERNAL-KEY. As any data transferred from the secret network 20 must be transferred via the interface unit 40, and will therefore be encrypted on a USB data storage device using the first key INTERNAL-KEY, and as only the first interface unit 60 is capable of decrypting data encrypted using the first key INTERNAL-KEY, any user wishing to transfer data out of the secret network 20 is forced to go via the secret stand-alone virus checker PC 70. Moreover, even if the USB stick 50 is lost or stolen, the fact that the data on it is encrypted means that the USB stick 50 is useless to third parties.

The secret stand-alone virus checker PC 70 performs a virus check on the data decrypted from the USB stick 50 and, assuming no viruses are found, then passes that data to the second interface unit 80. The second interface unit 80 is configured so that any data that it writes to a transfer USB stick 90 is encrypted. The encryption uses a second key CUSTOMER#1-KEY.

The second key CUSTOMER#1-KEY is known only to a first customer of the owner of the computer network 10. The USB stick 90, because it is encrypted, can be transferred to the first customer by normal means (for example the mail service) without fear of the confidentiality of the data that it carries being compromised.

In this example, the first customer has its own computer network 10′ which has an identical configuration to the computer network 10 described above. Handling of the transferred USB stick 90 after receipt by the first customer will now be described; it will be understood that, as the two networks 10 and 10′ are identical, data can also be transferred in the other direction, from the first customer's network 10′ to the network 10 and its handling in the network 10 will be the same as is about to be described with reference to the network 10′.

The transferred USB stick 90′ is received by the first customer, and inserted into the second interface unit 80′, which is configured to decrypt data on the transferred USB stick 90′ encrypted using the second key CUSTOMER#1-KEY (as well as, in this example, being configured to encrypt data onto a USB stick). The decrypted data is passed to the secret stand-alone virus checker PC 70′ which performs a virus check. Assuming no virus is found, the data is written by the first interface unit 60′ onto a USB stick 50′. The first interface unit 60′ writes the data onto the USB stick 50′ using a key CUST1INT-KEY known only to the first interface unit 60′ and the interface unit 40′ connected to the interface PC 30′ in the secret network 20′. Thus, the data on the USB stick 50′ encrypted using the key CUST1INT-KEY can be transferred only to the interface unit 40′. The interface unit 40′ decrypts the data from the USB stick 50′ and the data thereby reaches the secret PC 30′ and hence the secret network 20′.

Furthermore, data can only reach the secret network 20′ if it is encrypted using the key CUST1INT-KEY; thus, any attempt to introduce data from any other source maliciously or by accident will fail, as it will be rejected by the interface unit 40′. (Similarly, data can in this example only be introduced into the secret network 20 if it is encrypted using the key INTERNAL-KEY.)

As discussed above, the key CUSTOMER#1-KEY used to transfer data between the network 10 and the first customer's network 10′ is known only to the interface units 80, 80′ of the two networks 10, 10′. If data is to be transferred between the network 10 and a second customer's network 10″ (the internal structure of which is omitted from FIG. 1 for ease of illustration) a different key CUSTOMER#2-KEY is used and is known only to the interface units of those two networks 10, 10″. Importantly, the first and second customers need have no knowledge of each other's keys, CUSTOMER#1-KEY and CUSTOMER#2-KEY, respectively.

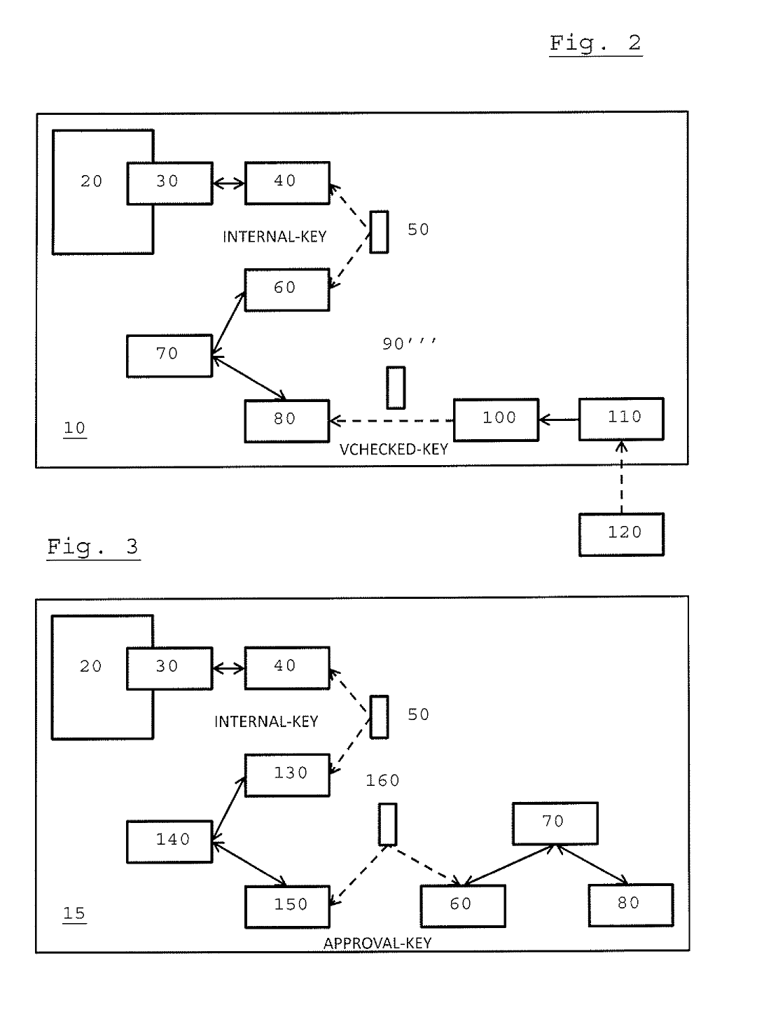

A disadvantage of the arrangement of the network 10 as described with respect to FIG. 1 is that the secret stand-alone virus-checker PC could itself potentially be compromised by malware introduced into the second interface unit 80. For example, there will typically be a need to introduce commercial software applications onto the secret stand-alone virus checker PC 70, for example updates to the virus-checking software containing details of recently discovered viruses, and there will also of course be the data on the memory stick 90′ or 90″ that is being transferred from the first or second customer, respectively; if any of those applications, updates or data have been compromised by malware then there is a danger that the secret stand-alone virus checker PC 70 will itself be compromised. In a second example embodiment (FIG. 2), that risk is managed by the introduction of an additional checking stage. Where items such as commercial software applications, virus updates, documents, or other data is to be introduced into the network 10, the data is first supplied on USB memory stick, CD-ROM or DVD 120 to an unclassified stand-alone virus-checker PC 110. If no virus or other malware is detected by that PC 110 then the data is written onto a USB stick 90″ by an encrypt-only interface unit 100 using a key VCHECKED-KEY. The key VCHECKED-KEY is shared only with the second interface unit 80, which decrypts the data and provides it to the secret standalone virus-checker PC. This arrangement ensures that all data reaching the secret stand-alone virus-checker PC has been pre-checked for malware, and hence also that all data reaching the secret network 20 has been twice checked for malware. The unclassified stand-alone virus-checker PC 110 and the secret stand-alone virus-checker PC 70 use different virus-checking software. It is expected that the vast majority of malware will be detected by the unclassified stand-alone virus-checker PC 110, but anything that escapes detection there would also have to evade detection by the secret stand-alone virus-checker PC 70 before it can reach the secret network 20.

In a third example embodiment of the invention (FIG. 3), a second compliance check is required in a network 15. The network 15 in this example is otherwise identical to the network 10 of the first and second examples. In addition to the virus checking by the secret standalone virus-checker PC 70, the operating procedures of the network 15 require that any removal of data from the secret networks 20 must be approved by an independent person. To that end, a further system is added in the air gap between the interface unit 40 connected to the secret interface PC 30 and the first interface 60 of the secret stand-alone virus-checker PC. The independent person uses a compliance-check PC 140 to check the data that is being removed from the secret network 20. Data removed from the secret network 20 is encrypted by the interface unit 40 on a USB stick 50 using the key INTERNAL-KEY, as described above. However, in this example the key INTERNAL-KEY is not provided to the first interface unit 60 but is instead provided only to the input interface unit 130 attached to the compliance-check PC 140; the USB stick 50 can therefore only be decrypted at the compliance-check PC 140. After decryption by the input interface unit 130, the independent person uses the compliance-check PC to check the decrypted data and, if it complies with the rules governing extraction of data from the secret network 20, approves the removal of the data. Once the approval is made, the data passes to an output interface unit 150, where it is encrypted onto a USB stick 160 using a further key APPROVAL-KEY. The further key APPROVAL-KEY is shared only with the first interface unit 60 of the secret standalone virus-checker PC 70, which decrypts the data so that it can be virus checked before passing out of the network 15, in a similar manner to that described in respect of the first example embodiment of the invention.

In each of the example embodiment is described above, the use of encryption keys known to only two interface devices ensures that the USB sticks used to transfer data across air gaps in the systems can only be used between those two interface devices. By combining pairs of interface devices in the systems, a single path into and out from the secret network 20 can be enforced, and hence a prescribed workflow (e.g. first virus check and then second virus check, as in the second example, or classification compliance check and then virus check, as in the second example) can be enforced. If a user were to attempt, accidentally or deliberately, to remove data from the system on a USB stick (or other memory storage device) without going through the prescribed workflow, that removal would not result in compromise of the data, because the encryption of data would ensure that no third party could read the data. At each step in the workflow, communication of data is only possible between the interface device of the sending part of the network (or of another trusted network) and the interface device of the receiving part of the network (or of another trusted part of the network), those being the only devices knowing the relevant encryption key.

A particular advantage of each of the example embodiments described above is that the encryption and decryption is carried out by dedicated hardware interface units 40, 60, 80 130, 150. Suitable hardware units are commercially available that are able to encrypt data, even of very high military classification levels, in such a way that the resultant encrypted data is encrypted sufficiently securely for it to be treated as unclassified data. In cases where the encryption is sufficiently strong for the resultant encrypted data to be treated as unclassified, that is particularly advantageous, as the USB sticks or other removable media used for data transfer need not be subject to any special handling requirements.

Whilst the present invention has been described and illustrated with reference to particular embodiments, it will be appreciated by those of ordinary skill in the art that the invention lends itself to many different variations not specifically illustrated herein. By way of example only, certain possible variations will now be described.

Although in this example, the first customer's network 10′ is identical to the network 10 first described above, in alternative embodiments of the invention, the customer may choose to implement a different network arrangement. For example, the customer may choose to omit the virus-checking stage and configure the interface unit 40′ to receive the transferred USB stick 90′ directly. Clearly, that results in an increased risk of the network 20′ being compromised, for example by a virus, but that may be an acceptable risk in some scenarios. Other additions or omissions of steps in the workflow into or out from the network are also possible.

In the systems described above, the data transfer is from an organisation to external customers. However, in other example embodiments of the invention the data transfer is between domains within a single organisation or site, for example between a secret network and an unrestricted network.

Also, in the above examples each of the interface units 40, 60, 80, 130, 150 has been configured both to encrypt and to decrypt data to and from USB sticks; in alternative embodiments, the encryption and decryption functions may be performed separately by distinct interface units.

Whilst in the above examples data transfer is by USB memory stick, the data transfer could of course be instead by other removable media, for example CD-ROM or DVD. Indeed, in some example embodiments of the invention, it may be acceptable for the network 10 to be connected by a network connection directly to anther network. In such a case, the data encrypted by the second encryption device 80 may be transferred directly to the other network, for example by FTP or e-mail over the network connection, without the need for removable media to be used. Clearly, such an arrangement poses an increased risk of compromise, but where that risk is considered acceptable on a security risk assessment, one or more air gaps in the examples described above may be replaced by direct network connections.

In some example embodiments of the invention the same removable medium is used for different transfer steps; i.e. a data transfer medium is re-used. Thus, for example, the USB memory sticks 50, 50′, 90 and 90′ may all be the same physical USB memory stick.

Although, as discussed above, it is advantageous for the encryption and/or decryption to be carried out in dedicated hardware units, in some example embodiments of the invention it may be acceptable for the encryption and/or decryption to be carried out in software. In such cases, the interface units 40, 60, 80, 100, 130, 150 performing the encryption and/or decryption may be embodied in software run on the interface PC 30, the secret standalone virus-checker PC 70, the unclassified virus-checker PC 110, or the compliance checker PC 140, respectively.

Where in the foregoing description integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims. Moreover, it is to be understood that such optional integers or features, whilst of possible benefit in some embodiments of the invention, may not be desirable, and may therefore be absent, in other embodiments.

1. A method of enforcing a data transfer policy when data is communicated from a private network, the method comprising ensuring that data can only be transferred via approved routes, through one or more intermediate compliance checkers, by:
encrypting, with a first encryption key, data that is leaving the private network;
transmitting the encrypted data to a compliance checker;
decrypting the encrypted data at the compliance checker;
checking that the decrypted data complies with a first condition; and
encrypting with a second, different, encryption key the checked, decrypted data.

2. A method as claimed in claim 1, in which the private network is not directly connected to any other computer network.

3. A method as claimed in claim 1, in which there is one or more further compliance check, enforced by sharing an encryption key between an input interface of a device that performs the further compliance check and an output interface of a device from which data to be checked for compliance is received, and sharing a different encryption key between an output interface of the device that performs the further compliance check and the input interface of a device to which the data that is to be sent after it has been checked for compliance.

4. A method as claimed in claim 1, in which the encryption is such that if the encrypted data is altered in any way then the decryption will fail.

5. A method as claimed in claim 1, in which the checking that the data complies with a first condition is a check that the data is data of a kind that is allowed to be removed from the private network.

6. A method of enforcing a data transfer policy when data is communicated to a private network, the method comprising ensuring that data can only be transferred via approved routes, through one or more intermediate compliance checkers, by:
receiving data that is encrypted with a first encryption key;
decrypting the encrypted data;
checking that the decrypted data complies with a first condition;
encrypting with a second, different, encryption key the checked, decrypted data;
transmitting the encrypted, checked data to a private network; and
decrypting the encrypted, checked data at the private network.

7. A computer network comprising:
a private network;
at least one interface connected to the private network and configured to encrypt, with a first encryption key, data that is leaving the private network;
a compliance check apparatus;
at least one interface connected to the compliance check apparatus and configured to decrypt data encrypted with the first encryption key that is entering the compliance check apparatus;
wherein the compliance check apparatus is configured to check that the decrypted data complies with a first condition; the computer network further comprising
at least one further interface connected to the compliance check apparatus and configured to encrypt with a second, different, encryption key checked, decrypted data that is leaving the compliance check apparatus.

8. A network as claimed in claim 7, in which each encryption key is shared only between one pair of the interfaces.

9. A network as claimed in claim 7, in which one or more of the encryption keys is shared between three or more of the interfaces, such that data encrypted by an interface sharing the key may be unencrypted by the two or more others of the interfaces sharing the key.

10. A network as claimed in claim 7, in which the data is transmitted between at least one pair of the interfaces on removable media.

11. A network as claimed in claim 7, in which the interface connected to the private network is the only device connected to the private network that is capable of writing data to removable media or to a network connection.

12. A network as claimed in claim 7, in which the data is transmitted between at least one pair of the interfaces over one or more network connections.

13. A network as claimed in claim 7, in which the interfaces are hardware devices connected directly to their respective functional devices, i.e. to the network, or to a compliance check apparatus.

14. A network as claimed in claim 7, in which any or all of the interfaces doing encryption only do encryption and/or any or all of the interfaces doing decryption only do decryption.

15. A computer network comprising:
a compliance check apparatus;
at least one interface connected to the compliance check apparatus and configured to decrypt data, encrypted with a first encryption key, that is entering the compliance check apparatus;
wherein the compliance check apparatus is configured to check that the decrypted data complies with a first condition, the computer network further comprising
at least one further interface connected to the compliance check apparatus and configured to encrypt with a second, different, encryption key checked, decrypted data that is leaving the compliance check apparatus;
a private network; and
at least one interface connected to the private network and configured to decrypt data, encrypted with the second encryption key, that is entering the private network.
